(19) United States
(12) Patent Application Publication
(10) Pub. No.: US 2015/0199701 A1
(43) Pub. Date: Jul. 16, 2015

(54) METHOD AND SYSTEM FOR TIME-BASED PROMOTIONAL POINT DECAY

(71) Applicant: MasterCard International Incorporated, Purchase, NY (US)

(72) Inventor: Kyle P. CLARK, High Ridge, MO (US)

(73) Assignee: MasterCard International Incorporated, Purchase, NY (US)

(21) Appl. No.: 14/154,744

(22) Filed: Jan. 14, 2014

(51) Int. Cl. G06Q 30/02

(52) U.S. Cl. CPC G06Q 30/0226

(57) ABSTRACT

A method for calculating a consumer reward includes: storing, in a promotion database, a promotion profile, wherein the promotion profile includes data related to a consumer promotion including at least a start time and/or date, an end time and/or date, a starting point value, and a rate of decay; receiving, by a receiving device, transaction data for a payment transaction, wherein the transaction data includes at least a transaction time and/or date; identifying, by a processing device, an elapsed time corresponding to time elapsed from the start time and/or date included in the promotion profile to the transaction time and/or date included in the received transaction data; and identifying, by the processing device, a reward point amount based on at least the identified elapsed time and the starting point value and the rate of decay included in the promotion profile.

### FIELD

The present disclosure relates to the calculation of a consumer reward, specifically the calculation of a consumer point reward for a payment transaction, where the point reward decays based on time since the start of the related promotion.

### BACKGROUND

A common method for merchants, manufacturers, retailers, payment card issuers, and other entities to encourage consumers to shop is to provide rewards for purchases. In some instances, the rewards may come in the form of points or other type of earnable currency that the consumer may accumulate and use to purchase items such as goods, services, gift cards, prizes, travel, etc. However, as multiple entities adopt such reward systems, consumers are often faced with decisions as to which payment card to use, merchant to shop at, etc. to earn rewards. For example, many consumers may have several payment cards, each of which may reward the consumer with reward points for purchased made using the card.

In an effort to curry the favor of a consumer, many payment card issuers and other entities may offer special promotions for earning rewards. For example, a merchant may hold a promotion to reward triple points to consumers during a specific period of time. Such a promotion may influence a consumer to shop at that merchant instead of a competing merchant due to the temporary increase in points. However, these promotions simply encourage consumers to make purchases at some point during the promotional period, without any urgency to taking advantage of such a promotion. As a result, some consumers may hold off on participating until a later time, and may eventually fail to participate altogether.

Thus, the present inventor believes there is a need for a technical solution to provide for time-based decay in promotional reward offerings to encourage consumers to take advantage of a promotion as quickly as possible.

### SUMMARY

The present disclosure provides a description of systems and methods for calculating consumer rewards.

A method for calculating a consumer reward includes: storing, in a promotion database, a promotion profile, wherein the promotion profile includes data related to a consumer promotion including at least a start time and/or date, an end time and/or date, a starting point value, and a rate of decay; receiving, by a receiving device, transaction data for a payment transaction, wherein the transaction data includes at least a transaction time and/or date; identifying, by a processing device, an elapsed time corresponding to time elapsed from the start time and/or date included in the promotion profile to the transaction time and/or date included in the received transaction data; and identifying, by the processing device, a reward point amount based on at least the identified elapsed time and the starting point value and the rate of decay included in the promotion profile.

Another method for calculating a consumer reward includes: storing, in a promotion database, a promotion profile, wherein the promotion profile includes data related to a consumer promotion including at least a promotion period, a starting point value, and a rate of decay; receiving, by a receiving device, an indication of receipt, wherein the indication of receipt indicates the receipt of the consumer promotion related to the promotion profile by a consumer and includes at least a receipt time and/or date; receiving, by the receiving device, transaction data for a payment transaction, wherein the transaction data includes at least a transaction time and/or date; identifying, by a processing device, an elapsed time corresponding to time elapsed from the receipt time and/or date included in the indication of receipt to the transaction time and/or date included in the received transaction data; and identifying, by the processing device, a reward point amount based on at least the identified elapsed time and the starting point value and the rate of decay included in the promotion profile.

A system for calculating a consumer reward includes a promotion database, a receiving device, and a processing device. The promotion database is configured to store a promotion profile, wherein the promotion profile includes data related to a consumer promotion including at least a start time and/or date, an end time and/or date, a starting point value, and a rate of decay. The receiving device is configured to receive transaction data for a payment transaction, wherein the transaction data includes at least a transaction time and/or date. The processing device is configured to: identify an elapsed time corresponding to time elapsed from the start time and/or date included in the promotion profile to the transaction time and/or date included in the received transaction data; and identify a reward point amount based on at least the identified elapsed time and the starting point value and the rate of decay included in the promotion profile.

Another system for calculating a consumer reward includes a promotion database, a receiving device, and a processing device. The promotion database is configured to store a promotion profile, wherein the promotion profile includes data related to a consumer promotion including at least a promotion period, a starting point value, and a rate of decay. The receiving device is configured to receive: an indication of receipt, wherein the indication of receipt indicates the receipt of the consumer promotion related to the promotion profile by a consumer and includes at least a receipt time and/or date; and transaction data for a payment transaction, wherein the transaction data includes at least a transaction time and/or date. The processing device is configured to: identify an elapsed time corresponding to time elapsed from the receipt time and/or date included in the indication of receipt to the transaction time and/or date included in the received transaction data; and identify a reward point amount based on at least the identified elapsed time and the starting point value and the rate of decay included in the promotion profile.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a high level architecture illustrating a system for calculating consumer rewards in accordance with exemplary embodiments.

FIG. 2 is a block diagram illustrating the processing server of FIG. 1 for the calculating of consumer rewards in accordance with exemplary embodiments.

FIG. 3 is a flow diagram illustrating a process for providing time-based decay in a promotional reward to a consumer using the system of FIG. 1 in accordance with exemplary embodiments.

FIG. 4 is a flow diagram illustrating a method for calculating a time-based decaying promotional reward using the processing server of FIG. 2 in accordance with exemplary embodiments.

FIGS. 5 and 6 are flow charts illustrating exemplary methods for calculating consumer rewards in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Definition of Terms

Payment Network—A system or network used for the transfer of money via the use of cash-substitutes. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, financial accounts, etc. Examples of networks or systems configured to perform as payment networks include those operated by MasterCard®, VISA®, Discover®, American Express®, PayPal®, etc.

Payment Account—A financial account that may be used to fund a transaction, such as a checking account, savings account, credit account, virtual payment account, etc. A payment account may be associated with an entity, which may include a person, family, company, corporation, governmental entity, etc. In some instances, a payment account may be virtual, such as those accounts operated by PayPal , etc.

Payment Card—A card or data associated with a payment account that may be provided to a merchant in order to fund a financial transaction via the associated payment account. Payment cards may include credit cards, debit cards, charge cards, stored-value cards, prepaid cards, fleet cards, virtual payment numbers, virtual card numbers, controlled payment numbers, etc. A payment card may be a physical card that may be provided to a merchant, or may be data representing the associated payment account (e.g., as stored in a communication device, such as a smart phone or computer). For example, in some instances, data including a payment account number may be considered a payment card for the processing of a transaction funded by the associated payment account. In some instances, a check may be considered a payment card where applicable.

### System for Calculating Consumer Rewards

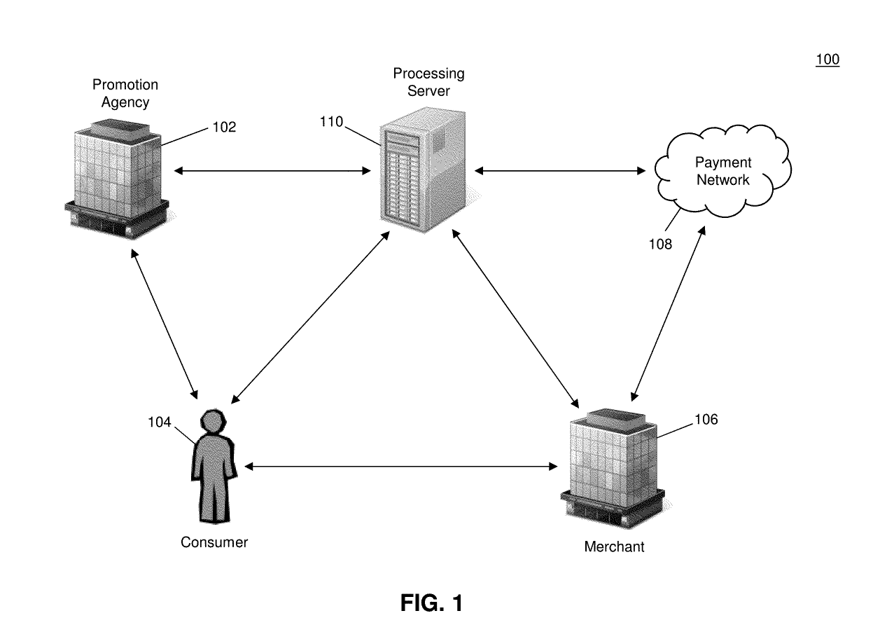

FIG. 1 illustrates a system 100 for calculating a consumer reward for a promotion with time-based decay of reward points.

The system 100 may include a promotion agency 102. The promotion agency 102 may put on a promotion for a predetermined period of time where a consumer 104 can earn points or any other suitable type of earnable and cumulative reward (hereinafter “points”) for purchases made during the promotional period of time. The promotion agency 102 may be a payment card issuer, merchant, manufacturer, payment network, retailer, offer provider, advertising agency, or any other suitable entity. The promotion agency 102 may transmit data associated with the promotion to a processing server 110, discussed in more detail below, for use in calculating a reward amount for eligible payment transactions. In one embodiment, the processing server 110 may be part of the promotion agency 102.

The consumer 104 may, once apprised of the promotion, conduct a payment transaction with a merchant 106 that is valid as part of the promotion. For example, if the promotion agency 102 is a payment card issuer, the consumer 104 may use a payment card issued by the promotion agency 102 that is eligible for the promotion to fund the payment transaction at the merchant 106. The merchant 106 may process the payment transaction via a payment network 108 using methods and systems that will be apparent to persons having skill in the relevant art. For example, the merchant 106 may transmit transaction data for the payment transaction from a point of sale to an acquirer, which may then generate and submit an authorization request for the payment transaction to the payment network 108.

Once the transaction has been completed, transaction data for the payment transaction may be transmitted to a processing server 110. In one embodiment, the transaction data may be provided by the payment network 108. In a further embodiment, the processing server 110 may be a part of the payment network 108. In another embodiment, the transaction data may be provided by the merchant 106. For example, in embodiments where the promotion agency 102 may be the merchant 106, the promotion agency 102 may transmit the transaction data to the processing server 110 for calculation of the consumer reward. In embodiments where the promotion agency 102 is also both the merchant 106 and the processing server 110, the processing server 110 may obtain the transaction data as part of the conducting of the payment transaction with the consumer 104.

The processing server 110, as discussed in more detail below, may then calculate a reward point amount for the payment transaction based on the data associated with the promotion. The reward point amount may be based on the amount of time elapsed since the start of the promotion to the payment transaction and a rate of decay for the promotion, as discussed below. In some embodiments, the amount of time elapsed may begin from a time at which the consumer 104 is notified of the promotion. For example, the promotion agency 102 may send out notices of a promotion to consumers 104, with the promotion beginning for each consumer 104 individually when they first view the promotion. In such an example, the promotion agency 102 may be able to stagger the participation in the promotion, which may assist with management of consumer traffic for a merchant 106, or may offer a promotion that is more convenient for consumers 104, which may make the consumers 104 more likely to participate.

Once the reward point amount has been calculated, the processing server 110 may notify the promotion agency 102 of the amount. The promotion agency 102 may then update the reward points for the consumer 104 to include the newly earned points and notify the consumer 104 of the update. In some embodiments, the processing server 110 may store consumer profiles for each consumer 104 and may update the consumer profile for the respective consumer 104 with the reward point amount. In some instances, the processing server 110 may transmit notifications of earned points to consumers 104 following calculations of reward point amounts.

The methods and systems discussed herein for calculating reward point amounts for promotions including time-based point decay may enable promotion agencies 102 and other entities to offer consumer promotions with additional control over traditional systems and additional participation. For example, consumers may be more encouraged to participate in a promotion that offers triple points one day, double points the next, and then returning to normal points on the third, than to participate in a promotion that offers triple points for three days due to urgency created by point decay. In addition, the ability for the promotion agency 102 to provide for point decay on an individual consumer basis may enable the promotion agency 102 to better manage consumer traffic at merchants (e.g., by staggering the promotion across different consumers over several days), accommodate for consumer behavioral differences (e.g., promotions beginning on Fridays for weekend shoppers or Mondays for weekday shoppers), as well as offer different promotions for different consumers (e.g., by varying starting points amounts or rates of decay for different consumers).

### Processing Server

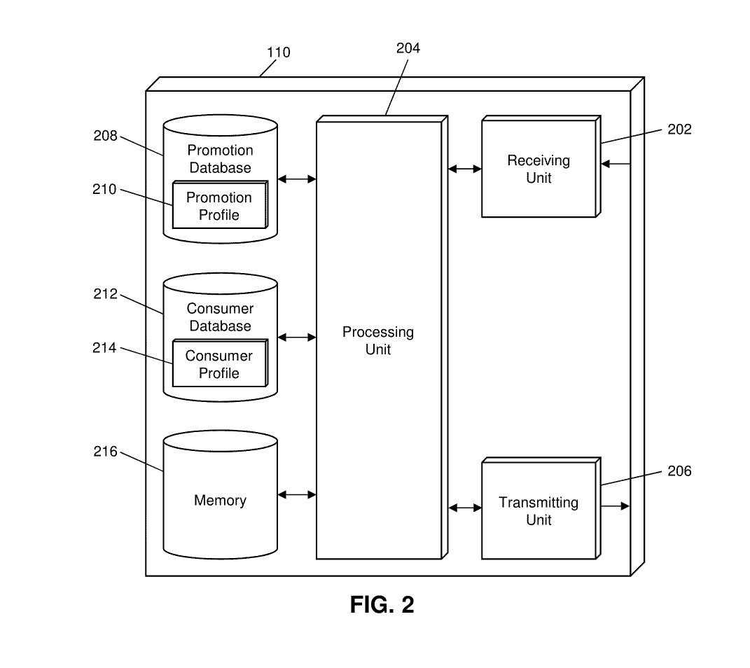

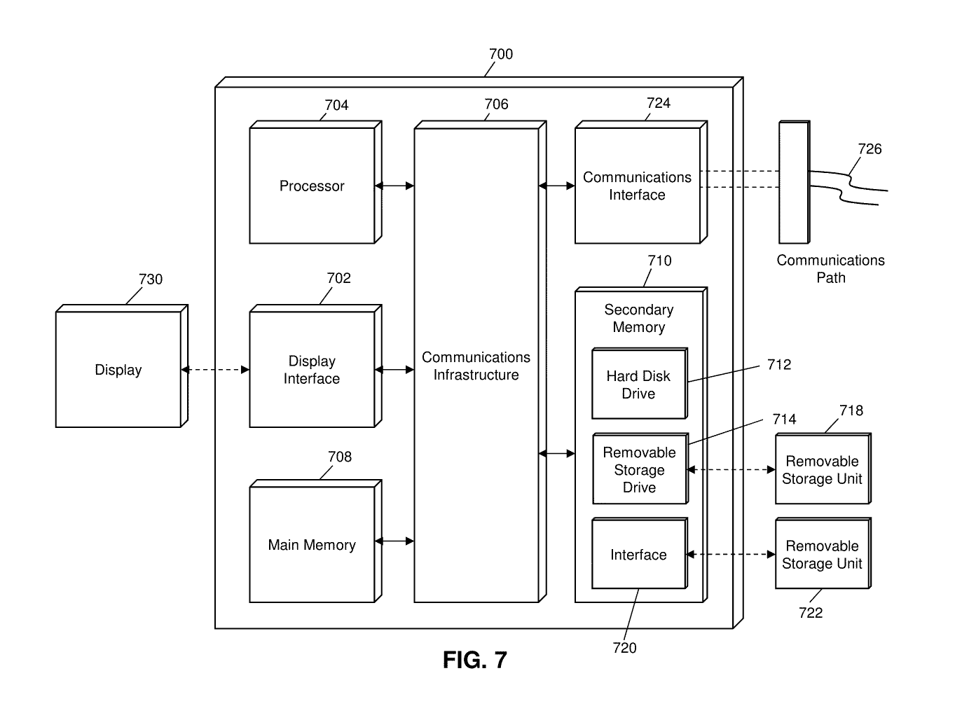

FIG. 2 illustrates an embodiment of the processing server 110 of the system 100. It will be apparent to persons having skill in the relevant art that the embodiment of the processing server 110 illustrated in FIG. 2 is provided as illustration only and may not be exhaustive to all possible configurations of the processing server 110 suitable for performing the functions as discussed herein. For example, the computer system 700 illustrated in FIG. 7 and discussed in more detail below may be a suitable configuration of the processing server 110.

The processing server 110 may include a receiving unit 202. The receiving unit 202 may be configured to receive data over one or more networks via one or more network protocols. The receiving unit 202 may receive data associated with a promotion offered by the promotion agency 102. The data may include at least a start time and/or date, an end time and/or date, a starting point value, and a rate of decay. The processing server 110 may also include a processing unit 204. The processing unit 204 may be configured to store the received data in a promotion database 208 as part of a promotion profile 210 related to the associated promotion.

Each promotion profile 210 may include the start time and/or date, the end time and/or date, the starting point value, and the rate of decay received for the related promotion. The start time and/or date may be the time and/or date at which the promotion begins and consumers 104 are eligible to earn reward points for transactions eligible under the promotion. In some instances, the start time and/or date may vary for each consumer 104. In such an instance, the promotion may also have an overall start date. For example, a promotion may begin when a consumer 104 views a notice of the promotion, but not earlier than a specific time and/or day.

The end time and/or date may be the time at which points may no longer be earned by consumers 104 as part of the promotion. In some embodiments, the end time and/or date may be an absolute time, such as January 1st at noon. In other embodiments, the end time and/or date may be a relative time, such as exactly three days from the start time and/or date. In some instances, the end time and/or date may vary from consumer to consumer, such as due to differences in start time and/or date or due to differences as stipulated by the promotion agency 102 (e.g., longer promotion periods for preferred consumers, etc.).

The start point amount may be the points earned by consumers 104 conducting transactions eligible in the related promotion at the start of the promotion before any time-based point decay. In some instances, the start point amount may vary from consumer to consumer. The rate of decay may be the rate at which the points awarded for eligible transactions conducted during the promotion decay from the starting point amount over the promotional period. In some instances, the rate of decay may be a linear rate, exponential rate, or any other suitable type of rate as will be apparent to persons having skill in the relevant art. In some embodiments, a promotion profile 210 may further include a decay algorithm. The decay algorithm may be an algorithm that is applied to calculate a reward point amount based on the starting point amount and the rate of decay.

In some instances, a promotion profile 210 may further include an ending point amount. The ending point amount may be a point amount that is awarded for eligible transactions conducted at the end of the promotional period. For example, a promotion may award quadruple points at the start of the period, but decay down to double points at the end of the promotional period. The promotion profile 210 may further include a grace period. The grace period may be a period of time after the start time and/or date before the rate of decay is applied to the starting point amount. For example, a promotion may include triple points for the first three days, the grace period, and then decay down to normal points after five more days.

The processing server 110 may further include a consumer database 212. The consumer database 212 may include a plurality of consumer profiles 214, each consumer profile 214 including data related to a consumer 104 including at least a consumer identifier and a point amount. The consumer identifier may be a unique value associated with the consumer profile 214 and/or related consumer 104 used for identification, such as an identification number, payment account number, e-mail address, phone number, etc. The point amount may be a total reward point amount earned by the consumer 104 and spendable for rewards with the promotion agency 102. It will be apparent to persons having skill in the relevant art that, in some embodiments, the consumer database 212 may be a part of the promotion agency 102.

In some embodiments, each promotion profile 210 may further include a consumer identifier associated with a consumer 104. In such an embodiment, a plurality of promotion profiles 210 may be associated with a single promotion, with each promotion profile 210 being associated with a single consumer 104 that may earn reward points through that promotion. In some instances, using individual promotional profiles 210 for each consumer may be suitable for including start time and/or dates, end time and/or dates, starting point amounts, ending point amounts, grace periods, rates of decay, etc. that vary from consumer to consumer. In other embodiments, each consumer profile 214 may include consumer-specific data for one or more promotions, such as individualized start time and/or dates for promotions. Additional data configurations suitable for performing the functions as disclosed herein will be apparent to persons having skill in the relevant art.

In some embodiments, each consumer profile 214 may further include consumer characteristics associated with the consumer 104. In such an embodiment, the consumer characteristics may be used in the calculation of reward point amounts for the respective consumers 104. For example, the consumer characteristics may include demographic characteristics (e.g., age, gender, income, marital status, familial status, residential status, zip code, postal code, occupation, education, etc.), and the reward point amount and/or eligibility for a promotion may be further based on the consumer's demographic characteristics, such as double points for all purchases with triple points to consumers aged 55 years or older. Consumer characteristics may further include transaction characteristics, spending behavior, or other data associated with the related consumer 104 suitable for performing the functions as discussed herein as will be apparent to persons having skill in the relevant art. In some instances, rates of decay may vary across different segments of consumers based on consumer characteristics.

The receiving unit 202 may be further configured to receive transaction data for a payment transaction eligible through a promotion related to a promotion profile 210 stored in the promotion database 208. The transaction data may include at least a transaction time and/or date and a consumer identifier. In some embodiments the transaction data may further include a transaction amount and any other data suitable for performing the functions as disclosed herein as will be apparent to persons having skill in the relevant art.

In some instances, a transaction may be eligible for one or more specific promotions. In such an instance, each promotion profile 210 may further include a promotion identifier, which may be a unique value suitable for identification of the respective promotion profile 210, such as an identification number. The received transaction data may then include one or more promotion identifiers corresponding to promotion profiles 210 related to promotions for which the transaction may be eligible. In some embodiments, the promotion profiles 210 may further include eligibility requirements. In such an embodiment, the processing unit 204 may identify eligibility of the payment transaction for each promotion based on transaction data and the eligibility requirements included in each promotion profile 210.

The processing unit 204 may also be configured to calculate an elapsed time corresponding to the time elapsed from the start time and/or date for each applicable promotion as included in the respective promotion profile 210 to the transaction time and/or date included in the received transaction data. In some instances, the processing unit 204 may take into account a grace period if included in the promotion profile 210. The processing unit 204 may be further configured to calculate a reward point amount for the payment transaction based on the calculated elapsed time and the starting point value and rate of decay included in the promotion profile 210. In some embodiments, the reward point amount may be further based on a transaction amount and/or other data included in the received transaction data, an ending point amount, and/or other suitable data as will be apparent to persons having skill in the relevant art.

In some instances, the processing unit 204 may calculate the reward point amount using one or more algorithms. The one or more algorithms may be stored in a memory 216 of the processing server 110 configured to store data used by the processing unit 204 and/or other units of the processing server 110 for performing the functions as disclosed herein. In instances where the promotion profile 210 may specify a particular algorithm for calculation of the reward point amount, the processing unit 204 may identify and use the particular algorithm as indicated in the promotion profile 210.

In some embodiments, the processing unit 204 may also be configured to update the total point amount for the consumer 104 involved in the payment transaction. In such an instance, the processing unit 204 may identify a consumer profile 214 in the consumer database 212 related to the consumer 104 based on the consumer identifier included in the consumer profile 214 and included in the received transaction data. The processing unit 204 may then update the total point amount based on the calculated point amount for the transaction.

The processing server 110 may also include a transmitting unit 206. The transmitting unit 206 may be configured to transmit data over one or more networks via one or more network protocols. The transmitting unit 206 may transmit the calculated reward point amount to the promotion agency 102. The promotion agency 102 may then use the reward point amount to update the points for the consumer 104 and/or to notify the consumer 104 of the earned points. In some embodiments, the transmitting unit 206 may also transmit a notification to the consumer 104 of the earned points.

### Process for Earning, Calculating, and Providing Time-Based Consumer Rewards

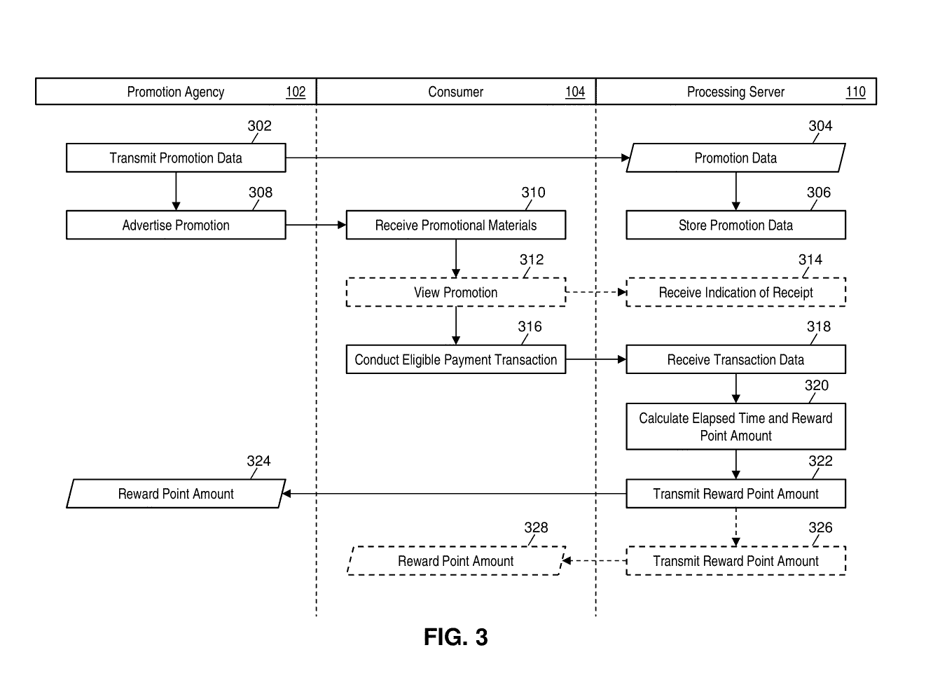

FIG. 3 illustrates a process for providing time-based consumer rewards to the consumer 104 for a promotion-eligible transaction subject to time-based decay of reward points.

In step 302, the promotion agency 102 may transmit promotion data to the processing server 110 for a promotion being offered to consumers. The promotion data may include at least a start time and/or date, an end time and/or date, a starting point amount, and a rate of decay. In step 304, the receiving unit 202 of the processing server 110 may receive the promotion data. In step 306, the processing unit 204 may generate and store a promotion profile 210 in the promotion database 208 including the received promotion data.

In step 308, the promotion agency 102 may advertise the promotion or otherwise provide notice of the promotion to consumers. In step 310, the consumer 104 may receive the promotion advertisement. In step 312, the consumer 104 may view the promotion advertisement. In step 314, the receiving unit 202 of the processing server 110 may receive an indication of the viewing and/or receipt of the promotion by the consumer 104. For example, the consumer 104 may receive the promotion advertisement via a mobile device, such as a smart phone, which may identify when the consumer 104 views the advertisement and may subsequent transmit an indication of the viewing and/or receipt of the advertisement to the processing server 110 (e.g., via the promotion agency 102). The processing server 110 may then identify the time of receipt and/or viewing of the advertisement as the start time and/or date for the individual consumer 104. It will be apparent to persons having skill in the relevant art that steps 312 and 314 may be optional steps. For example, steps 312 and 314 may not be performed in instances where a promotion has a single start time and/or date for all consumers.

In step 316, the consumer 104 may conduct an eligible payment transaction with the merchant 106. In step 318, the receiving unit 202 of the processing server 110 may receive transaction data for the payment transaction from the payment network 108 and/or the merchant 106. The transaction data may include at least a transaction time and/or date for the payment transaction. In step 320, the processing unit 204 may calculate the time elapsed from the start time and/or date of the promotion to the transaction time and/or date, and may calculate a reward point amount based on the elapsed time and the starting point amount and rate of decay for the promotion.

In step 322, the transmitting unit 206 of the processing server 110 may transmit the calculated reward point amount to the promotion agency 102, which may receive the reward point amount in step 324. In step 326, the transmitting unit 206 may also transmit the calculated reward point amount to the consumer 104 to notify the consumer 104 of the earned points from the eligible transaction. In step 328, the consumer 104 may receive the notice of the earned reward points. It will be apparent to persons having skill in the relevant art that steps 326 and 328 may be optional steps.

### Process for Calculating Consumer Reward Point Amounts

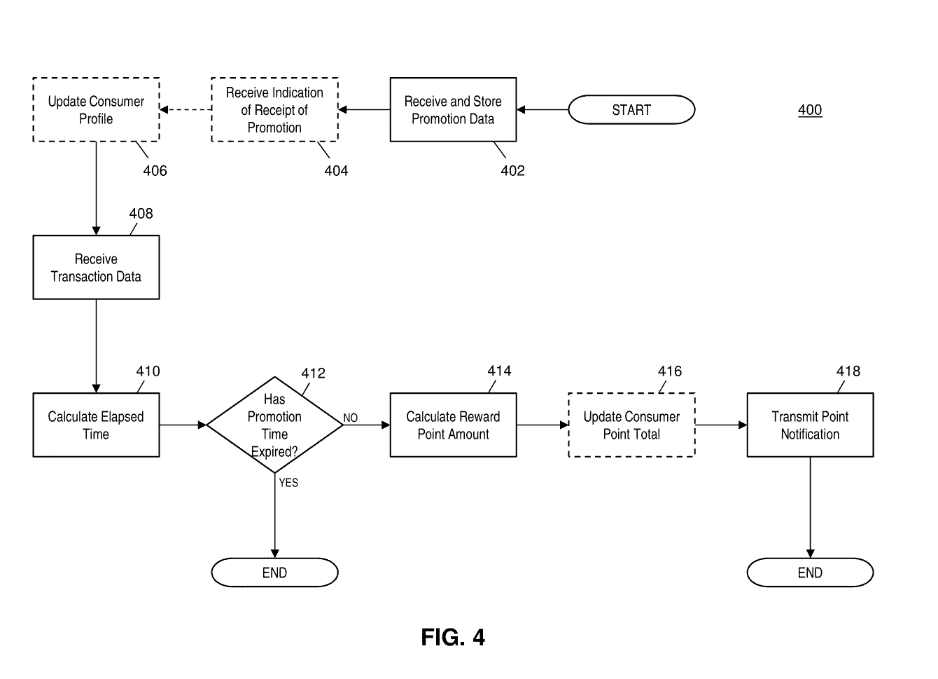

FIG. 4 illustrates a process 400 for calculating consumer reward point amounts based on promotion and transaction data by the processing server 110 for promotion rewards subject to time-based point decay.

In step 402, the receiving unit 202 may receive promotion data from the promotion agency 102, which may be stored in a promotion profile 210 of the promotion database 208 by the processing unit 204. The promotion data may include at least a start time and/or date, an end time and/or date, a starting point amount, and a rate of decay. In some embodiments, the promotion data may further include at least one of: a promotion identifier, a consumer identifier, an ending point amount, and a point algorithm.

In step 404, the receiving unit 202 may receive an indication of receipt and/or viewing of a promotion by a consumer 104. The indication of receipt may include a promotion identifier and/or consumer identifier and may further include a receipt time and/or date. In step 406, the processing unit 204 may update the corresponding consumer profile 214 and/or promotion profile 210 that includes the promotion identifier and/or consumer identifier included in the indication. Updating the profile may include updating the start time and/or date for the promotion for the corresponding consumer 104 to the receipt time and/or date included in the indication. It will be apparent to persons having skill in the relevant art that steps 404 and 406 may be optional.

In step 408, the receiving unit 202 may receive transaction data. The received transaction data may include at least a transaction time and/or date. In some embodiments, the transaction data may further include at least a transaction amount. In step 410, the processing unit 204 may calculate the elapsed time representing time elapsed from the start time and/or date included in the promotion profile 210 to the transaction time and/or date in the received transaction data. In one embodiment, the elapsed time may be further based on a grace period included in the promotion profile 210.

In step 412, the processing unit 204 may determine if the promotion time has expired. The determination may be based on the transaction time and/or date being later than the end time and/or date for the promotion, or the elapsed time being greater than the end time and/or date for the promotion. If the promotion time has expired, and therefore the payment transaction no longer eligible under the promotion, then the process 400 may be completed. In some instances, the transmitting unit 206 may transmit a notification to the consumer 104 and/or the processing agency 102 notifying that the payment transaction is no longer eligible.

If the time for the promotion has not expired, and the payment transaction thereby still eligible under the promotion, then, in step 414, the processing unit 204 may calculate the reward point amount based on at least the identified elapsed time and the starting point value and rate of decay included in the promotion profile 210. In one embodiment, the reward point amount calculation may be further based on an ending point amount included in the promotion profile 210 and/or a decay algorithm, which may be stored in the memory 216.

In step 416, the processing unit 204 may update a point total in a consumer profile 214 stored in the consumer database 212 related to the consumer 104 involved in the transaction based on the calculated reward point amount. It will be apparent to persons having skill in the relevant art that step 416 may be an optional step. For example, step 416 may not be performed in instances where the processing server 110 does not include the consumer database 212. In step 418, the transmitting unit 206 may transmit a notification including the calculated reward point amount to the promotion agency 102 and/or the consumer 104.

### First Exemplary Method for Calculating a Consumer Reward

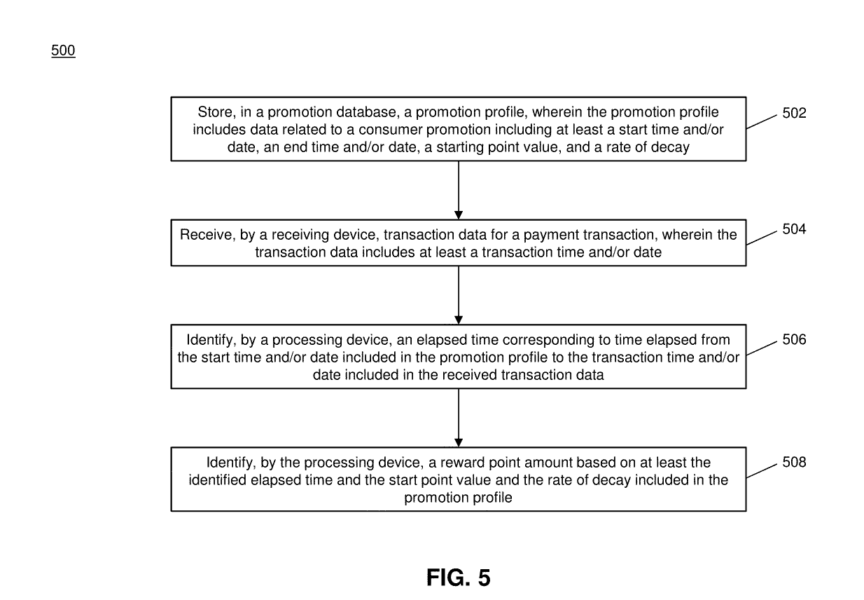

FIG. 5 illustrates a method 500 for calculating a consumer reward for a promotion subject to time-based point decay.

In step 502, a promotion profile (e.g., the promotion profile 210) may be stored in a promotion database (e.g., the promotion database 208), wherein the promotion profile 210 includes data related to a consumer promotion including at least a start time and/or date, an end time and/or date, a starting point value, and a rate of decay. In step 504, transaction data for a payment transaction may be received by a receiving device (e.g., the receiving unit 202), wherein the transaction data includes at least a transaction time and/or date. In certain exemplary embodiments, the transaction data may further include a consumer identifier.

In step 506, an elapsed time corresponding to time elapsed from the start time and/or date included in the promotion profile 210 to the transaction time and/or date included in the received transaction data may be identified by a processing device (e.g., the processing unit 204). In one embodiment, the promotion profile 210 may further include a grace period, and the elapsed time may correspond to time elapsed from a time following the start time and/or date and the grace period included in the promotion profile 210 to the transaction time and/or date included in the received transaction data.

In step 508, a reward point amount may be identified, by the processing device 204, based on at least the identified elapsed time and the start point value and the rate of decay included in the promotion profile 210. In one embodiment, the transaction data may further include a transaction amount, and the reward point amount may be further based on the transaction amount. In some embodiments, the promotion profile 210 may further include an algorithm identifier, and the reward point amount may be further based on at least the rate of decay and the identified elapsed time to an algorithm corresponding to the algorithm identifier included in the promotion profile 210. In one embodiment, the reward point amount may be zero if the transaction time and/or date included in the received transaction data is after the end time and/or date included in the promotion profile.

In one embodiment, the promotion profile 210 may further include a recipient (e.g., the promotion agency 102) and the transaction data may further include a consumer identifier associated with a consumer (e.g., the consumer 104) involved in the payment transaction. In a further embodiment, the method 500 may further include transmitting, by a transmitting device (e.g., the transmitting unit 206), at least the identified reward point amount and the consumer identifier included in the transaction data to the recipient included in the promotion profile 210.

In one embodiment, the method 500 may further include: storing, in a consumer database (e.g., the consumer database 212), a consumer profile (e.g., the consumer profile 214), wherein the consumer profile 214 includes at least a point total; and updating, in the consumer database 212, the point total of the consumer profile 214 based on the identified reward point amount.

### Second Exemplary Method for Calculating a Consumer Reward

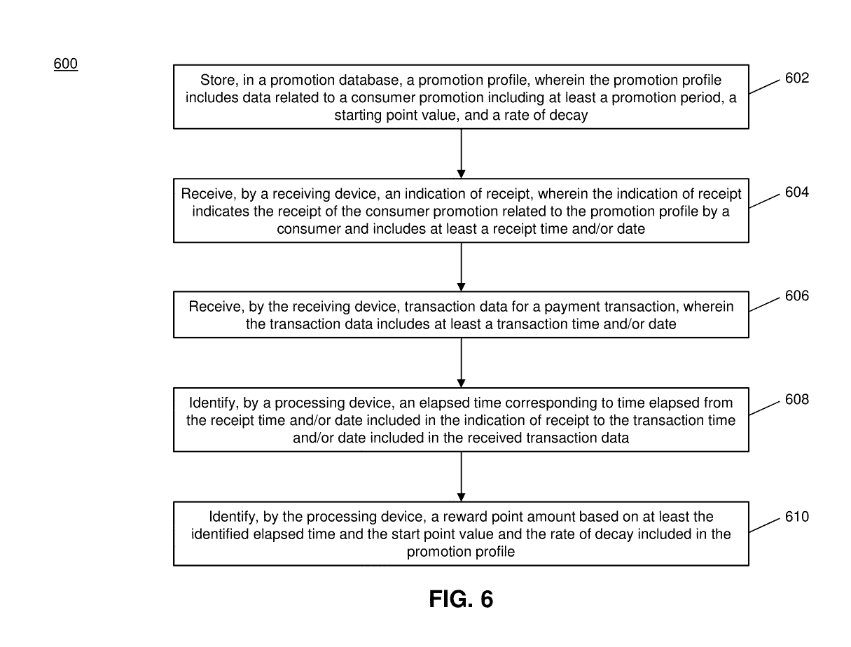

FIG. 6 illustrates an alternative method 600 for calculating a consumer reward for a promotion subject to time-based point decay.

In step 602, a promotion profile (e.g., the promotion profile 210) may be stored in a promotion database (e.g., the promotion database 208), wherein the promotion profile 210 includes data related to a consumer promotion including at least a promotion period, a starting point value, and a rate of decay. In step 604, an indication of receipt may be received by a receiving device (e.g., the receiving unit 202), wherein the indication of receipt indicates the receipt of the consumer promotion related to the promotion profile 210 by a consumer (e.g., the consumer 104) and includes at least a receipt time and/or date. In step 606, transaction data for a payment transaction may be received by the receiving device 202, wherein the transaction data includes at least a transaction time and/or date.

In step 608, an elapsed time corresponding to time elapsed from the receipt time and/or date included in the indication of receipt to the transaction time and/or date included in the received transaction data may be identified by a processing device (e.g., the processing unit 204). In one embodiment, the promotion profile 210 may further include a grace period, and the elapsed time may correspond to time elapsed from a time following the receipt time and/or date in the received indication of receipt and the grace period included in the promotion profile 210 to the transaction time and/or date included in the received transaction data.

In step 610, a reward point amount may be identified, by the processing device 204, based on at least the identified elapsed time and the start point value and the rate of decay included in the promotion profile 210. In one embodiment, the transaction data may further include a transaction amount, and the reward point amount may be further based on the transaction amount. In some embodiments, the promotion profile 210 may further include an algorithm identifier, and the reward point amount may be further based on at least the rate of decay and the identified elapsed time to an algorithm corresponding to the algorithm identifier included in the promotion profile 210. In one embodiment, the reward point amount may be zero if the transaction time and/or date included in the received transaction data is after the end time and/or date included in the promotion profile.

In one embodiment, the method 600 may further include transmitting, by a transmitting device (e.g., the transmitting unit 206), at least the identified reward point amount to the consumer 104. In some embodiments, the method 600 may further include: storing, in a consumer database (e.g., the consumer database 212), a consumer profile (e.g., the consumer profile 214), wherein the consumer profile 214 includes data related to the consumer 104 including at least a point total; and updating, in the consumer database 212, the point total of the consumer profile 214 based on the identified reward point amount. In another embodiment, the consumer profile 214 may additionally, or alternatively, include consumer characteristics associated with the consumer 104, and the reward point amount may be further based on the consumer characteristics stored in the consumer profile 214.

### Computer System Architecture

FIG. 7 illustrates a computer system 700 in which embodiments of the present disclosure, or portions thereof, may be implemented as computer-readable code. For example, the processing server 110 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform or a special purpose device. A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 717, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 707 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 717 in a well-known manner. The removable storage unit 717 may include a removable storage media that may be read by and written to by the removable storage drive 714. For example, if the removable storage drive 714 is a floppy disk drive or universal serial bus port, the removable storage unit 717 may be a floppy disk or portable flash drive, respectively. In one embodiment, the removable storage unit 717 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 707 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 707 and secondary memory 710, which may be memory semiconductors (e.g., DRAMs, etc.). These computer program products may be means for providing software to the computer system 700. Computer programs (e.g., computer control logic) may be stored in the main memory 707 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

Techniques consistent with the present disclosure provide, among other features, systems and methods for calculating a consumer reward. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for calculating a consumer reward, comprising:
storing, in a promotion database, a promotion profile, wherein the promotion profile includes data related to a consumer promotion including at least a start time and/or date, an end time and/or date, a starting point value, and a rate of decay;
receiving, by a receiving device, transaction data for a payment transaction, wherein the transaction data includes at least a transaction time and/or date;
identifying, by a processing device, an elapsed time corresponding to time elapsed from the start time and/or date included in the promotion profile to the transaction time and/or date included in the received transaction data; and
identifying, by the processing device, a reward point amount based on at least the identified elapsed time and the starting point value and the rate of decay included in the promotion profile.

2. The method of claim 1, wherein
the promotion profile further includes a recipient,
the transaction data further includes a consumer identifier associated with a consumer involved in the payment transaction, and
the method further comprises:
transmitting, by a transmitting device, at least the identified reward point amount and the consumer identifier included in the transaction data to the recipient included in the promotion profile.

3. The method of claim 1, further comprising:
storing, in a consumer database, a consumer profile, wherein the consumer profile includes at least a point total; and
updating, in the consumer database, the point total of the consumer profile based on the identified reward point amount.

4. The method of claim 1, wherein
the transaction data further includes a transaction amount, and
the reward point amount is further based on the transaction amount.

5. The method of claim 1, wherein
the promotion profile further includes an algorithm identifier, and
the reward point amount is further based on application of at least the rate of decay and the identified elapsed time to an algorithm corresponding to the algorithm identifier included in the promotion profile.

6. The method of claim 1, wherein
the promotion profile further includes a grace period, and
the elapsed time corresponds to time elapsed from a time following the start time and/or date and the grace period included in the promotion profile to the transaction time and/or date included in the received transaction data.

7. The method of claim 1, wherein the reward point amount is zero if the transaction time and/or date included in the received transaction data is after the end time and/or date included in the promotion profile.

8. A method for calculating a consumer reward, comprising:
storing, in a promotion database, a promotion profile, wherein the promotion profile includes data related to a consumer promotion including at least a promotion period, a starting point value, and a rate of decay;
receiving, by a receiving device, an indication of receipt, wherein the indication of receipt indicates the receipt of the consumer promotion related to the promotion profile by a consumer and includes at least a receipt time and/or date;
receiving, by the receiving device, transaction data for a payment transaction, wherein the transaction data includes at least a transaction time and/or date;
identifying, by a processing device, an elapsed time corresponding to time elapsed from the receipt time and/or date included in the indication of receipt to the transaction time and/or date included in the received transaction data; and
identifying, by the processing device, a reward point amount based on at least the identified elapsed time and the starting point value and the rate of decay included in the promotion profile.

9. The method of claim 8, further comprising:
transmitting, by a transmitting device, at least the identified reward point amount to the consumer.

10. The method of claim 8, further comprising:
storing, in a consumer database, a consumer profile, wherein the consumer profile includes data related to the consumer including at least a point total; and
updating, in the consumer database, the point total of the consumer profile based on the identified reward point amount.

11. The method of claim 8, wherein
the transaction data further includes a transaction amount, and
the reward point amount is further based on the transaction amount.

12. The method of claim 8, wherein
the promotion profile further includes an algorithm identifier, and
the reward point amount is further based on application of at least the rate of decay and the identified elapsed time to an algorithm corresponding to the algorithm identifier included in the promotion profile.

13. The method of claim 8, wherein
the promotion profile further includes a grace period, and
the elapsed time corresponds to time elapsed from a time following the receipt time and/or date included in the received indication of receipt and the grace period included in the promotion profile to the transaction time and/or date included in the received transaction data.

14. The method of claim 8, wherein the reward point amount is zero if the identified elapsed time exceeds the promotion period included in the promotion profile.

15. The method of claim 8, further comprising:
storing, in a consumer database, a consumer profile, wherein the consumer profile includes data related to the consumer including at least consumer characteristics, wherein
the reward point amount is further based on the consumer characteristics stored in the consumer profile.

16. A system for calculating a consumer reward, comprising:
a promotion database configured to store a promotion profile, wherein the promotion profile includes data related to a consumer promotion including at least a start time and/or date, an end time and/or date, a starting point value, and a rate of decay;
a receiving device configured to receive transaction data for a payment transaction, wherein the transaction data includes at least a transaction time and/or date; and
a processing device configured to
identify an elapsed time corresponding to time elapsed from the start time and/or date included in the promotion profile to the transaction time and/or date included in the received transaction data, and
identify a reward point amount based on at least the identified elapsed time and the starting point value and the rate of decay included in the promotion profile.

17. The system of claim 16, further comprising:
a transmitting device, wherein
the promotion profile further includes a recipient,
the transaction data further includes a consumer identifier associated with a consumer involved in the payment transaction, and
the transmitting device is configured to at least the identified reward point amount and the consumer identifier included in the transaction data to the recipient included in the promotion profile.

18. The system of claim 16, further comprising:
a consumer database configured to store a consumer profile, wherein the consumer profile includes at least a point total, wherein
the processing device is further configured to update, in the consumer database, the point total of the consumer profile based on the identified reward point amount.

19. The system of claim 16, wherein
the transaction data further includes a transaction amount, and
the reward point amount is further based on the transaction amount.

20. The system of claim 16, wherein
the promotion profile further includes an algorithm identifier, and
the reward point amount is further based on application of at least the rate of decay and the identified elapsed time to an algorithm corresponding to the algorithm identifier included in the promotion profile.

21. The system of claim 16, wherein
the promotion profile further includes a grace period, and
the elapsed time corresponds to time elapsed from a time following the start time and/or date and the grace period included in the promotion profile to the transaction time and/or date included in the received transaction data.

22. The system of claim 16, wherein the reward point amount is zero if the transaction time and/or date included in the received transaction data is after the end time and/or date included in the promotion profile.

23. A system for calculating a consumer reward, comprising:
a promotion database configured to store a promotion profile, wherein the promotion profile includes data related to a consumer promotion including at least a promotion period, a starting point value, and a rate of decay;
a receiving device configured to receive
an indication of receipt, wherein the indication of receipt indicates the receipt of the consumer promotion related to the promotion profile by a consumer and includes at least a receipt time and/or date, and
transaction data for a payment transaction, wherein the transaction data includes at least a transaction time and/or date; and
a processing device configured to
identify an elapsed time corresponding to time elapsed from the receipt time and/or date included in the indication of receipt to the transaction time and/or date included in the received transaction data, and
identify a reward point amount based on at least the identified elapsed time and the starting point value and the rate of decay included in the promotion profile.

24. The system of claim 23, further comprising:
a transmitting device configured to transmit at least the identified reward point amount to the consumer.

25. The system of claim 23, further comprising:
a consumer database configured to store a consumer profile, wherein the consumer profile includes data related to the consumer including at least a point total, wherein
the processing device is further configured to update, in the consumer database, the point total of the consumer profile based on the identified reward point amount.

26. The system of claim 23, wherein
the transaction data further includes a transaction amount, and
the reward point amount is further based on the transaction amount.

27. The system of claim 23, wherein
the promotion profile further includes an algorithm identifier, and
the reward point amount is further based on application of at least the rate of decay and the identified elapsed time to an algorithm corresponding to the algorithm identifier included in the promotion profile.

28. The method of claim 8, wherein
the promotion profile further includes a grace period, and
the elapsed time corresponds to time elapsed from a time following the receipt time and/or date included in the received indication of receipt and the grace period included in the promotion profile to the transaction time and/or date included in the received transaction data.

29. The system of claim 23, wherein the reward point amount is zero if the identified elapsed time exceeds the promotion period included in the promotion profile.

30. The system of claim 23, further comprising:
a consumer database configured to store a consumer profile, wherein the consumer profile includes data related to the consumer including at least consumer characteristics, wherein
the reward point amount is further based on the consumer characteristics stored in the consumer profile.
